(19) United States
(12) Patent Application Publication
(10) Pub. No.: US 2016/0279737 A1
(43) Pub. Date: Sep. 29, 2016

(54) LASER DRILLING THROUGH MULTI-LAYER COMPONENTS

(71) Applicant: PRATT & WHITNEY CANADA CORP., Longueuil (CA)

(72) Inventor: Ludwik STRACH, McMasterville (CA)

(21) Appl. No.: 14/669,071

(22) Filed: Mar. 26, 2015

(51) Int. Cl. B23K 26/06; B23K 26/40; B23K 26/38

(52) U.S. Cl. CPC B23K 26/063; B23K 26/381; B23K 26/4085

(57) ABSTRACT

There is described herein a method and system for drilling holes in components having multiple layers of materials using a laser emitting device, by controlling the laser pulses in such a way that cracks at the interfaces between the various materials are minimized or eliminated.

### TECHNICAL FIELD

The present invention relates to the field of drilling holes in components having two or more layers of materials, whereby drilling is performed by means of a laser emitting device.

### BACKGROUND OF THE ART

Standard drilling methods are based on laser pulses repetitively fired at one position on a component, thus producing a hole.

Although laser drilling has many advantages, when drilling through components having multiple layers, cracks may form at the interface of the different layers. There is a need to minimize such cracking.

### SUMMARY

There is described herein a method and system for drilling holes in components having multiple layers of materials using a laser emitting device, by controlling the laser pulses in such a way that cracks at the interfaces between the various materials are minimized or eliminated.

In accordance with a first broad aspect, there is provided a method for drilling a hole in a component with a laser, the component composed of at least a first layer of a first material and a second layer of a second material different from the first material. The method comprises setting a first layer pulse duration in a millisecond range; setting a first layer pulse shape defining a varying energy level over time for a first layer pulse; setting a second layer pulse duration in the millisecond range; setting a second layer pulse shape defining a varying energy level over time for a second layer pulse; generating at least one first layer pulse with a laser having the first layer pulse duration and the first layer pulse shape to drill through the first layer; and generating at least one second layer pulse with the laser having the second layer pulse duration and the second layer pulse shape to drill through the second layer.

In accordance with another broad aspect, there is provided a system for drilling a hole in a component, the component composed of at least a first layer of a first material and a second layer of a second material different from the first material. The system comprises a control unit comprising a processor and a memory; and a user interface operatively connected to the control unit. The user interface is responsive to user input for causing the processor of the control unit to set a first layer pulse duration in a millisecond range; set a first layer pulse shape defining a varying energy level over time for a first layer pulse; set a second layer pulse duration in the millisecond range; and set a second layer pulse shape defining a varying energy level over time for a second layer pulse. The system also comprises a laser emitting device operatively connected to the control unit and configured for receiving command signals from the control unit and applying at least one first layer pulse having the first layer pulse duration and the first layer pulse shape to drill through the first layer and at least one second layer pulse having the second layer pulse duration and the second layer pulse shape to drill through the second layer.

In accordance with another broad aspect, there is provided a computer readable medium having stored thereon program code executable by a processor for causing a laser emitting device to drill a hole in a component, the component composed of at least a first layer of a first material and a second layer of a second material different from the first material. The program code comprises instructions for setting a first layer pulse duration in a millisecond range; setting a first layer pulse shape defining a varying energy level over time for a first layer pulse; setting a second layer pulse duration in the millisecond range; setting a second layer pulse shape defining a varying energy level over time for a second layer pulse; sending a first command to the laser emitting device to generate at least one first layer pulse having the first layer pulse duration and the first layer pulse shape to drill through the first layer; and sending a second command to the laser emitting device to generate at least one second layer pulse with the laser having the second layer pulse duration and the second layer pulse shape to drill through the second layer.

In accordance with yet another broad aspect, there is provided a method for drilling a hole in a component, the component composed of at least a first layer of a first material and a second layer of a second material different from the first material. The method comprises drilling through the first layer by applying at least one first pulse from a laser, the at least one first pulse having a first pulse duration in a millisecond range and a first pulse shape defining a varying energy level over time; and drilling through the second layer by applying at least one second pulse from the laser, the at least one second pulse having a second pulse duration in a millisecond range and a second pulse shape defining a varying energy level over time, at least one of the first pulse duration and the first pulse shape being different from the second pulse duration and the second pulse shape, respectively.

### BRIEF DESCRIPTION OF THE DRAWINGS

Further features and advantages of the present invention will become apparent from the following detailed description, taken in combination with the appended drawings, in which:

FIG. 1 is a top perspective view of an exemplary component having a first layer and a second layer and a hole drilled therethrough;

FIG. 2 is a cross-sectional view of an exemplary component having a first layer that acts as a coating to a second layer, with a hole drilled therethrough;

FIG. 3a is an exemplary embodiment of a system for drilling holes in components having multiple layers;

FIG. 3b is another exemplary embodiment of a system for drilling holes in components having multiple layers;

FIG. 4 is a block diagram of an exemplary embodiment for a control unit in the system of FIG. 3a or 3b;

FIG. 5 is a flowchart of an exemplary method for drilling holes in components having multiple layers;

FIG. 6a is a graph of a pulse train as per the prior art;

FIG. 6b is a graph of a pulse train with pulses having a varying energy level over time, in accordance with one embodiment;

FIG. 6c is a graph of pulse trains for multiple layers, in accordance with one embodiment; and

FIG. 7 is a cross-sectional view of the component of FIG. 1.

It will be noted that throughout the appended drawings, like features are identified by like reference numerals.

### DETAILED DESCRIPTION

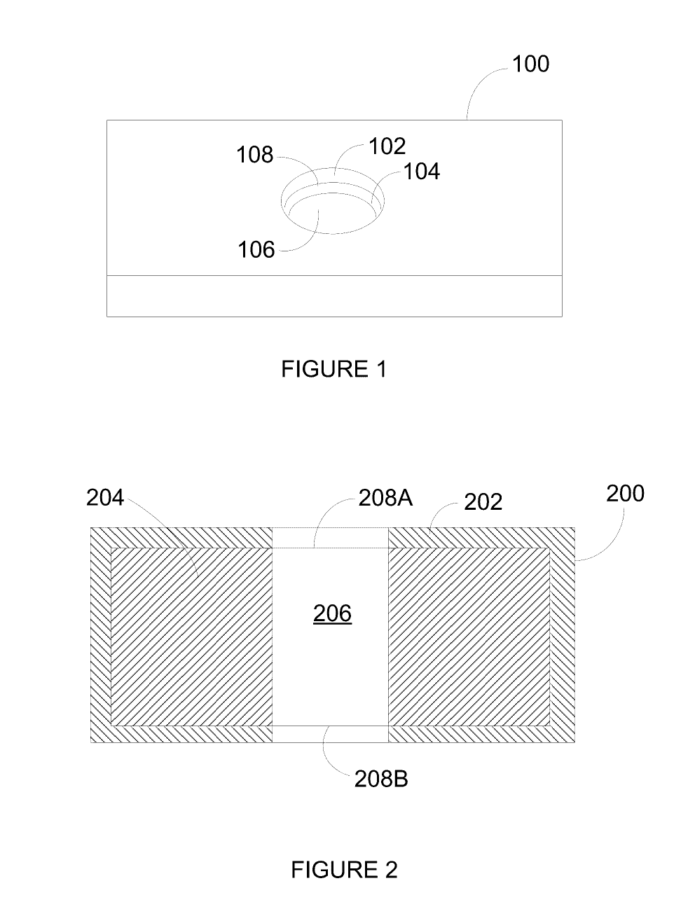

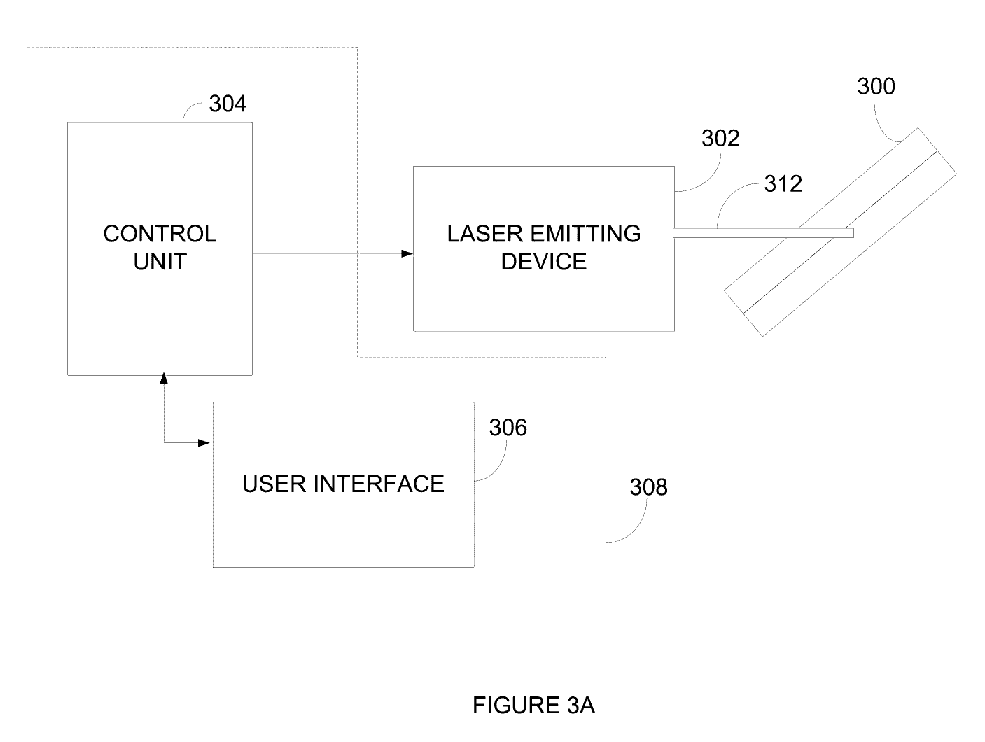

FIG. 1 is an exemplary embodiment of a component 100 formed from a first layer 102 and a second layer 104, seen through a hole 106 drilled therethrough. An interface 108 forms a common boundary between the first layer 102 and the second layer 104. The component 100 may be an aircraft component, such as a blade, vane, or heat shield. The component 100 may be used for other types of vehicles, such as ships, trains, and automobiles, or for other applications, such as power plants, wind turbines, and damns. The component 100 may be a composite material, made from two or more constituent materials. The component 100 may also comprise one or more primary materials forming a substrate, such as metal, plastic, ceramic, glass, concrete, and/or polymer, and one or more coating materials, such as a thermal barrier coating (TBC), a paint, and/or a lacquer. An exemplary embodiment is illustrated in FIG. 2, whereby a component 200 is formed of a first layer 202 that acts as a coating on a second layer 204. A hole 206 is shown to have been drilled through the top coating of the first layer 202, the second layer 204, and the bottom coating of the first layer 202. In this example, a first interface 208a is at the boundary between the top coating of the first layer 202 and the second layer 204, and a second interface 208b is at the boundary between the second layer 204 and the bottom coating of the first layer 202. The technique described herein is used to minimize and/or eliminate the cracks that may occur at interfaces 108, 208a, 208b, due to the differences in the properties of the various materials making up the layers of the components 100, 200, and thus the differences in optimal drilling parameters for each layer.

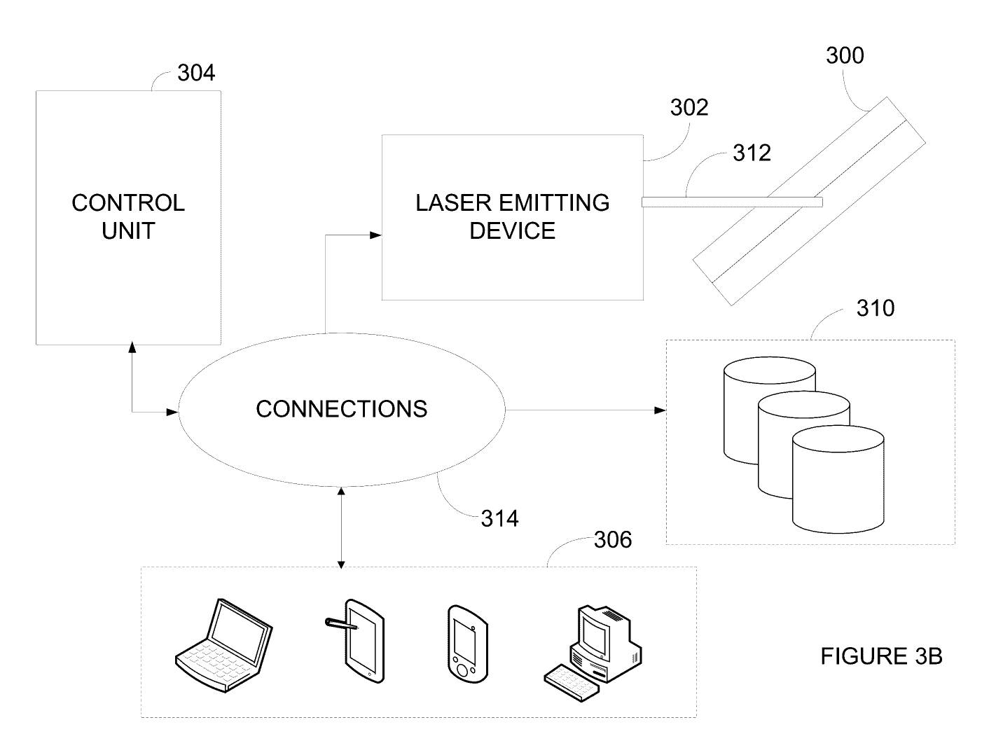

FIG. 3a illustrates an exemplary embodiment of a system for drilling holes in a component 300 composed of at least a first layer and a second layer of material. A laser emitting device 302 generates a beam 312 for drilling a hole in the component 300. The laser emitting device 302 may include a laser, focusing optics, and any other elements used to generate and emit the laser beam 312, such as a power supply. The laser may be a fiber laser, a solid state laser, or a gas laser. In some embodiments, the laser is a lamp-pumped Nd:YAG laser that emits light with a wavelength of 1064 nm. In some embodiments, the laser is a multimode (MM) fiber laser that emits light with a wavelength of 1070 nm. Other types of lasers that operate in the infrared or near-infrared range at a wavelength of about 1080 nm or less may also be used. The laser emitting device 302 generates pulses in the millisecond range in order to drill through the material using a thermal effect. The thermal effect comprises heating, melting, and/or vaporizing of the material. The pulses may thus be of a duration that ranges from about 0.1 milliseconds to about 10 milliseconds, and in some embodiments about 0.6 milliseconds to about 1.0 milliseconds. Each pulse may have an energy from about 1 Joule to about 150 Joules. In some embodiments, the hole to be drilled corresponds to the size of the beam 312, which may range from about 0.1 mm to about 1.0 mm, and in some embodiments from about 0.1 to about 0.5 mm, or from about 0.5 to about 0.75 mm (in diameter). The spot size may be changed from layer to layer as a function of the material. The spot size may be maintained constant throughout a given layer.

A control unit 304 is operatively connected to the laser emitting device 302. The connection may be a wired or wireless connection, such that the control unit 304 may transmit command signals to the laser emitting device 302 for generating the laser beam 312. A user interface 306 is operatively connected to the control unit 304, for causing the control unit 304 to set pulse parameters for drilling through the layers of the component 300. In some embodiments, the control unit 304 and the user interface 306 are provided separately and are connected together through a wired or wireless connection. Alternatively, the user interface 306 is integrated with the control unit 304 as a single device 308. For example, the user interface 306 may be a control panel provided on the device 308. In some embodiments, the device 308 is a power supply and the control unit 304 is a hardware and/or software component inside the power supply. Alternatively, the device 308 is provided externally to the power supply, which is part of the laser emitting device 302.

FIG. 3b is an exemplary embodiment whereby the user interface 306 is a computing device. The control unit 304 may be accessible remotely from any one of the computing devices over connections 314. The computing device may comprise any device, such as a personal computer, a tablet, a smart phone, or the like, which is configured to communicate over the connections 314 with the control unit 304. In some embodiments, the control unit 304 may itself be provided directly on one of the computing devices, either as a downloaded software application, a firmware application, or a combination thereof. The laser emitting device 302 may also be accessible by the control unit 304 via the connections 314.

Various types of connections 314 may be provided to allow the user interface 306 to communicate with the control unit 304 and/or the control unit 304 to communicate with the laser emitting device 302. For example, the connections 314 may comprise wire-based technology, such as electrical wires or cables, and/or optical fibers. The connections 314 may also be wireless, such as RF, infrared, Wi-Fi, Bluetooth, and others. Connections 314 may therefore comprise a network, such as the Internet, the Public Switch Telephone Network (PSTN), a cellular network, or others known to those skilled in the art. Communication over the network may occur using any known communication protocols that enable devices within a computer network to exchange information. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol). The connections 314 between the control unit 304 and the user interface 306 may be the same or different from the connections between the laser emitting device 302 and the control unit 304. For example, the laser emitting device 302 may be wired to the control unit 304 while the control unit 304 and the user interface 306 communicate wirelessly. Alternatively, both connections may be wired or wirelessly but using different technology.

One or more databases 310 may be integrated directly into the control unit 304 or any one of the devices forming the user interface 306, or may be provided separately therefrom (as illustrated). In the case of a remote access to the databases 310, access may occur via connections 314 taking the form of any type of network, as indicated above. The various databases 310 described herein may be provided as collections of data or information organized for rapid search and retrieval by a computer. The databases 310 may be structured to facilitate storage, retrieval, modification, and deletion of data in conjunction with various data-processing operations. The databases 310 may be any organization of data on a data storage medium, such as one or more servers. The databases 310 illustratively have stored therein any one of pulse durations, pulse shapes, material types, material thicknesses, drilling angles, and gas pressures.

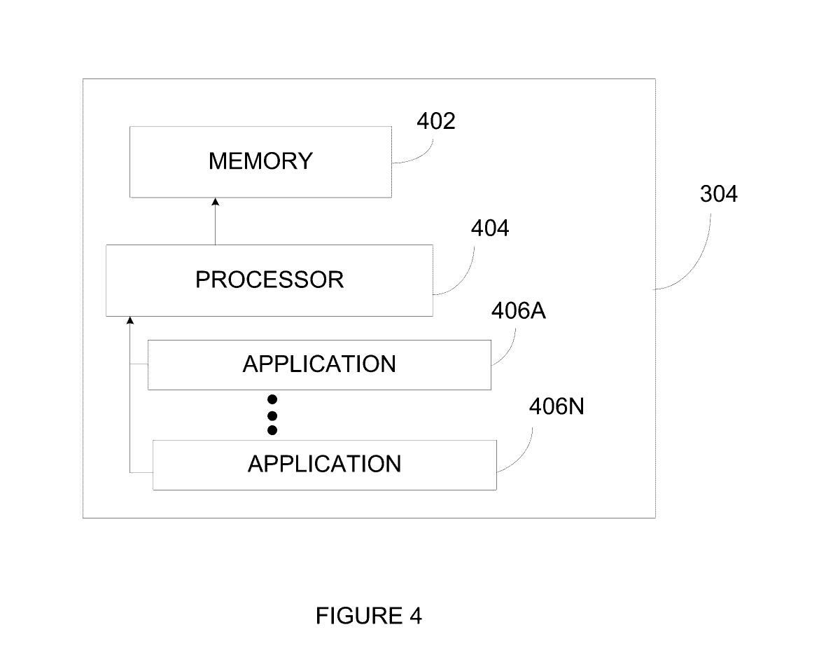

As shown in FIG. 4, the control unit 304 illustratively comprises, amongst other things, a plurality of applications 406a . . . 406n running on a processor 404 coupled to a memory 402. It should be understood that while the applications 406a . . . 406n presented herein are illustrated and described as separate entities, they may be combined or separated in a variety of ways. The memory 402 accessible by the processor 404 may receive and store data. The memory 402 may be a main memory, such as a high speed Random Access Memory (RAM), or an auxiliary storage unit, such as a hard disk, a floppy disk, or a magnetic tape drive. The memory 402 may be any other type of memory, such as a Read-Only Memory (ROM), or optical storage media such as a videodisc and a compact disc. The processor 404 may access the memory 402 to retrieve data. The processor 404 may be any device that can perform operations on data. Examples are a central processing unit (CPU), a front-end processor, a microprocessor, and a network processor. The applications 406a . . . 406n are coupled to the processor 404 and configured to perform various tasks.

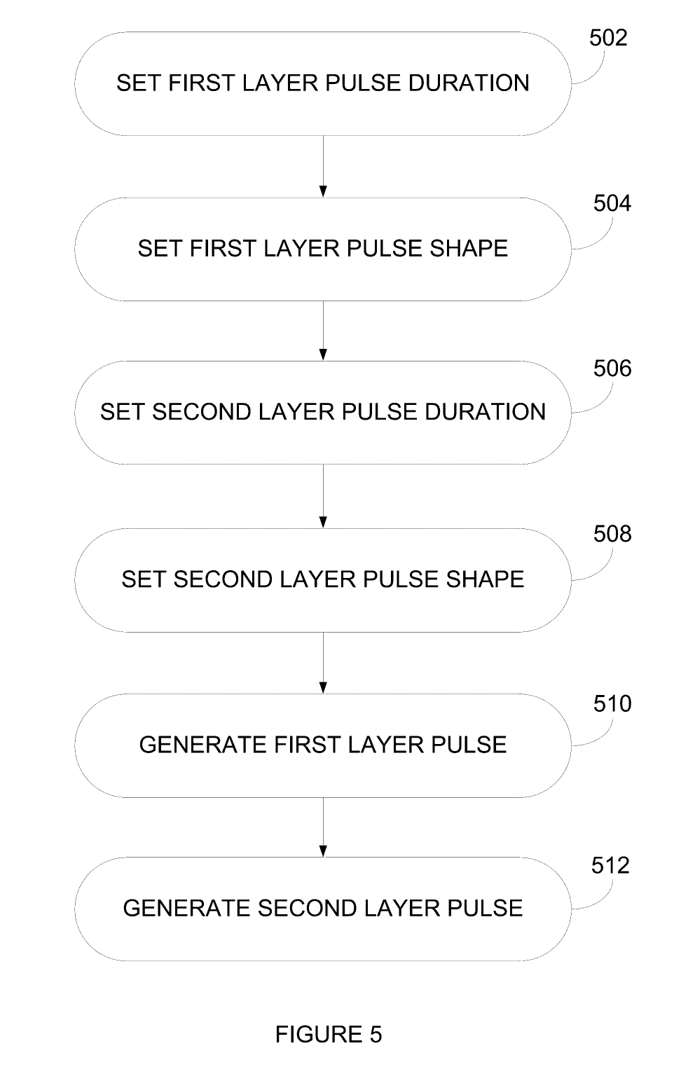

FIG. 5 is an exemplary embodiment of a method for drilling holes in components composed of at least a first layer and a second layer of material. The user interface 306 is responsive to user input for causing the processor 404 of the control unit 304 to set a first layer pulse duration in a millisecond range as per step 502, set a first layer pulse shape defining a varying energy level over time for a first layer pulse as per step 504, set a second layer pulse duration in the millisecond range as per step 506, and set a second layer pulse shape defining a varying energy level over time for a second layer pulse as per step 508. The control unit 304 is configured for providing the laser emitting device 302 with command signals for generating at least one first layer pulse having the first layer pulse duration and the first layer pulse shape to drill through the first layer as per step 510, and generating at least one second layer pulse having the second layer pulse duration and the second layer pulse shape to drill through the second layer as per step 512.

The steps of the method may be repeated for N layers, whereby the Nth layer pulse duration and Nth layer pulse shape are set by the control unit 304, and the Nth layer pulse is applied by the laser emitting device 302. The pulse durations and pulse shapes may be set for all layers before any pulses are applied. Alternatively, the parameters for a first layer are set, at least one pulse having those parameters is applied, and the parameters for a subsequent layer are set after the first layer has been drilled. In some embodiments, the operator of the laser emitting device 302 may decide the order of the steps to be performed.

In some embodiments, setting the pulse shape and/or pulse duration comprises receiving a user defined pulse shape and/or duration. For example, the user interface 306 may be configured to allow the user to enter a specific value for pulse duration, such as 0.25 ms, using a keypad or a touchscreen. The user interface 306 may also be configured to allow the user to shape the pulse as desired, for example using a mouse or a touchscreen. Alternatively, the user interface 306 may be configured to allow the user to select from multiple predefined pulse shapes and/or durations, for example using a dropdown menu or a set of numbered input keys. Other means of providing user-defined inputs may also be used.

In some embodiments, setting the pulse shape and/or pulse duration comprises receiving drilling parameters related to the drilling procedure and/or component, to be used by the control unit 304 for selecting pulse shape and/or duration. For example, the user may enter, via the user interface 306, information such as a material type for each layer, a material thickness for each layer, a number of layers, a drilling angle, a hole shape, or other information that may be used to determine an optimal pulse shape and/or duration. For example, a drilling angle may vary from about 15 to about 90 degrees and this may affect the selection of an optimal pulse shape and/or duration. The control unit 304 may be configured to select, based on the received drilling parameters, from a list of predefined pulse durations and/or pulse shapes, based on predetermined configurations. For example, the control unit 304 may be configured to choose from three predetermined pulse shapes for drilling through metal, and the selection of which one of the three pulse shapes may be made based on additional information such as the thickness of the metal layer. A predetermined setting may associate a given pulse shape and/or duration with a given material having a thickness ranging between x and y units. Other such associations may also be provided. The control unit 304 may be configured to access a look-up table with the predetermined settings and select, based on the drilling parameters, an optimal pulse shape and/or duration for each layer of material of the component.

In some embodiments, the memory 402 of the control unit 304 is a computer readable medium having stored thereon program code executable by the processor 404 for causing the laser emitting device 302 to drill holes in the component 300 composed of at least a first layer and a second layer of material. The program code comprises instructions for setting a first layer pulse duration in a millisecond range; setting a first layer pulse shape defining a varying energy level over time for a first layer pulse; setting a second layer pulse duration in the millisecond range; and setting a second layer pulse shape defining a varying energy level over time for a second layer pulse. The program code also comprises instructions for sending a first command to the laser emitting device 302 to generate at least one first layer pulse having the first layer pulse duration and the first layer pulse shape to drill through the first layer; and sending a second command to the laser emitting device 302 to generate at least one second layer pulse with the laser having the second layer pulse duration and the second layer pulse shape to drill through the second layer.

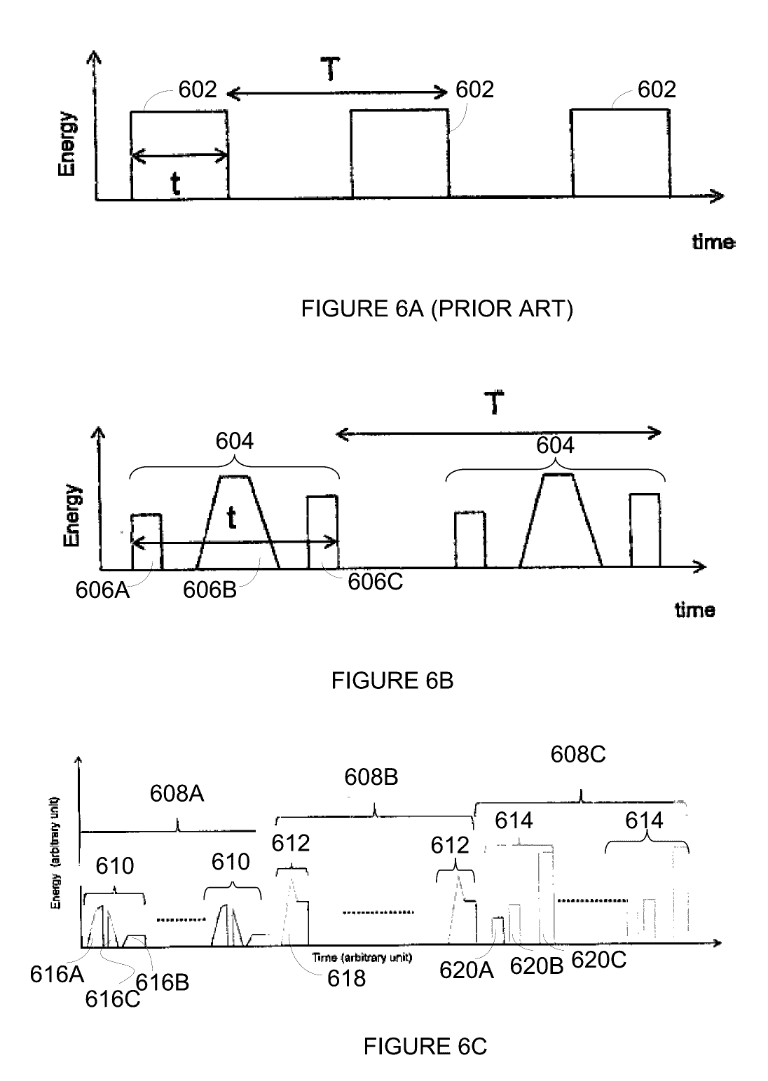

FIG. 6a illustrates a set of pulses 602 in accordance with the prior art. Each pulse 602 has a duration t and the pulse train has a period T. The frequency of the laser is 1/T. FIG. 6b illustrates a first exemplary embodiment of a pulse train having two pulses 604, each pulse 604 having a varying level of energy over time. In some embodiments, and as illustrated in this example, a pulse 604 of duration t is segmented into segments, such as segments 606a, 606b, 606c. Each segment is separated by an energy level of zero within the single pulse 604. Segment 606a has a same shape as segment 606c but a lower energy level, while segment 606b differs from segments 606a and 606c in shape and energy level. Pulse 604 is applied at least once for drilling through a given level, and may be repeated several times. Segmented pulses 604 may comprise two or more segments, of varying or same shape, and of varying or same energy level.

FIG. 6c is illustrates an example of pulses for a first layer 608a, a second layer 608b, and a third layer 608c of a given component. For the first layer 608a, a pulse 610 is segmented into three segments 616a, 616b, 616c and applied m times to the first layer to drill therethrough. For the second layer 608b, a pulse 612 is unsegmented but shaped with a varying energy level over time 618, and applied n times to the second layer to drill therethrough. For the third layer 608c, a pulse 614 is segmented into three segments 620a, 620b, 620c and applied p times to the third layer to drill therethrough. Each layer is thus drilled through with a pulse shape that is optimal, a pulse duration that is optimal, and a number of pulses that are optimal for the drilling parameters of the layer.

The pulse shapes and/or pulse durations and/or number of pulses applied may be the same or different from one layer to another, depending on the drilling parameters of each layer. As such, setting a second layer pulse shape as per step 508 may comprise selecting a pulse shape different from the first layer pulse shape. Setting a second layer pulse duration as per step 506 may comprise selecting a pulse duration different from the first layer pulse duration. Applying at least one second layer pulse as per step 512 may comprise applying a different number of pulses to the second layer than applied to the first layer.

In some embodiments, the method further comprises setting a first layer laser frequency and setting a second layer laser frequency. Applying at least one first layer pulse with a laser comprises using the first layer laser frequency and applying at least one second layer pulse with the laser comprises using the second layer laser frequency. Note that the frequency of the laser may vary from one layer to another. As such, setting a second layer laser frequency may comprise selecting a laser frequency different from the first layer laser frequency.

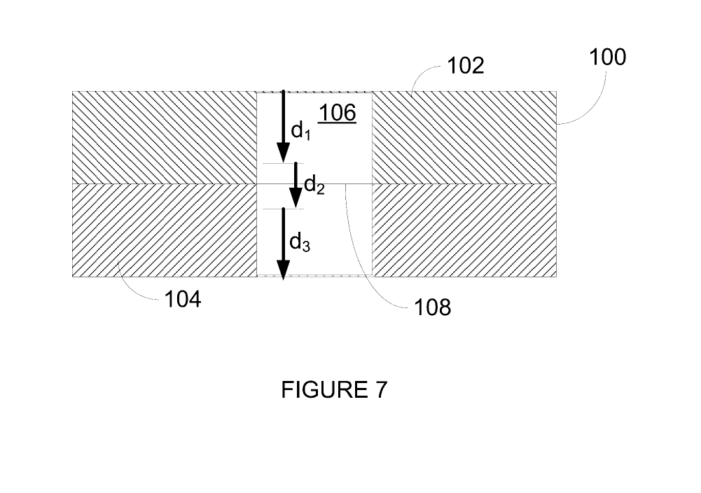

In some embodiments, pulse shape and/or duration may vary within a same layer of material. For example, a first portion of the first layer may be drilled through using pulses 610, while a second portion of the first layer may be drilled through using pulses 612. This technique may be used, for example, for thicker material where the change in pulse shape and/or duration occurs closer to the interface with the second layer, in order to speed up the drilling process. Only the portion of the first layer that interfaces with the second layer is drilled through using given settings, while the rest of the component is drilled through using other settings. For example, referring to FIG. 7, there is illustrated a cross-sectional view of the component 100 of FIG. 1. Depth d₁ is contained entirely in the first layer 102, depth d₂ straddles the first layer 102 and the second layer 104, and depth d₃ is contained entirely in the second layer 104. Drilling of depths d₁ and d₃ may occur using same or different beam parameters (i.e. pulse duration, pulse shape), while drilling of depth d₂ may occur using a different set of beam parameters in order to account for the interface 108 between the first layer 102 and the second layer 104.

In some embodiments, the method for drilling holes in components composed of at least a first layer and a second layer of material comprises setting a first pulse duration in a millisecond range, setting a first pulse shape defining a varying energy level over time for a first pulse, setting a second pulse duration in the millisecond range, and setting a second pulse shape defining a varying energy level over time for a second pulse. At least one first pulse having the first pulse duration and the first pulse shape is applied to drill through a portion of the component that does not comprise an interface between the first layer and the second layer, and at least one second pulse having the second pulse shape and the second pulse duration is applied to drill through a portion of the component that comprises the interface between the first layer and the second layer.

In some embodiments, the system for drilling holes in components composed of at least a first layer and a second layer of material comprises a control unit comprising a processor and a memory, and a user interface operatively connected to the control unit. The user interface is responsive to user input for causing the processor of the control unit to set a first pulse duration in a millisecond range, set a first pulse shape defining a varying energy level over time for a first pulse, set a second pulse duration in the millisecond range, and set a second pulse shape defining a varying energy level over time for a second pulse. The system also comprises a laser emitting device operatively connected to the control unit and configured for receiving command signals from the control unit and applying at least one first pulse having the first pulse duration and the first pulse shape to drill through a portion of the component that does not comprise an interface between the first layer and the second layer and at least one second pulse having the second pulse shape and the second pulse duration to drill through a portion of the component that comprises the interface between the first layer and the second layer.

In some embodiments, the computer readable medium having stored thereon program code executable by a processor for causing a laser emitting device to drill holes in components composed of at least a first layer and a second layer of material comprises instructions for comprises setting a first pulse duration in a millisecond range, setting a first pulse shape defining a varying energy level over time for a first pulse, setting a second pulse duration in the millisecond range, and setting a second pulse shape defining a varying energy level over time for a second pulse. The program code also comprises instructions for sending a first command to the laser emitting device to generate at least one first pulse having the first pulse duration and the first pulse shape to drill through a portion of the component that does not comprise an interface between the first layer, and sending a second command to the laser emitting device to generate at least one second pulse having the second pulse shape and the second pulse duration to drill through a portion of the component that comprises the interface between the first layer and the second layer.

All of the embodiments described with regards to FIGS. 1 to 6 are applicable to the method, system, and computer readable medium as described with regards to FIG. 7.

The above description is meant to be exemplary only, and one skilled in the relevant arts will recognize that changes may be made to the embodiments described without departing from the scope of the invention disclosed. For example, the blocks and/or operations in the flowcharts and drawings described herein are for purposes of example only. There may be many variations to these blocks and/or operations without departing from the teachings of the present disclosure. For instance, the blocks may be performed in a differing order, or blocks may be added, deleted, or modified. While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment. The present disclosure may be embodied in other specific forms without departing from the subject matter of the claims. Also, one skilled in the relevant arts will appreciate that while the systems, methods and computer readable mediums disclosed and shown herein may comprise a specific number of elements/components, the systems, methods and computer readable mediums may be modified to include additional or fewer of such elements/components. The present disclosure is also intended to cover and embrace all suitable changes in technology. Modifications which fall within the scope of the present invention will be apparent to those skilled in the art, in light of a review of this disclosure, and such modifications are intended to fall within the appended claims.

1. A method for drilling a hole in a component with a laser, the component composed of at least a first layer of a first material and a second layer of a second material different from the first material, the method comprising:
setting a first layer pulse duration in a millisecond range;
setting a first layer pulse shape defining a varying energy level over time for a first layer pulse;
setting a second layer pulse duration in the millisecond range;
setting a second layer pulse shape defining a varying energy level over time for a second layer pulse;
generating at least one first layer pulse having the first layer pulse duration and the first layer pulse shape to drill the hole through the first layer; and
generating at least one second layer pulse having the second layer pulse duration and the second layer pulse shape to drill the hole through the second layer.

2. The method of claim 1, wherein at least one of setting a first layer pulse shape and setting a second layer pulse shape comprises selecting a shape comprising at least two segments separated by an energy level of zero within a single pulse.

3. The method of claim 2, wherein at least one of generating at least one first layer pulse and generating at least one second layer pulse comprises generating the single pulse multiple times.

4. The method of claim 1, wherein setting a second layer pulse shape comprises selecting a pulse shape different from the first layer pulse shape.

5. The method of claim 4, wherein setting a second layer pulse duration comprises selecting a pulse duration different from the first layer pulse duration.

6. The method of claim 5, wherein applying at least one second layer pulse comprises generating a different number of pulses to the second layer than generated for the first layer.

7. The method of claim 1, further comprising setting a first layer laser frequency and setting a second layer laser frequency, and wherein generating at least one first layer pulse with a laser comprises using the first layer laser frequency and generating at least one second layer pulse with the laser comprises using the second layer laser frequency.

8. The method of claim 7, wherein setting a second layer laser frequency comprises selecting a laser frequency different from the first layer laser frequency.

9. The method of claim 1, wherein generating the at least one first layer pulse comprises generating a pulse with a first spot size and generating the at least one second layer pulse comprises generating a pulse with a second spot size different from the first spot size.

10. The method of claim 9, wherein a diameter of the spot size is from about 0.1 mm to about 0.5 mm.

11. A system for drilling a hole in a component, the component composed of at least a first layer of a first material and a second layer of a second material different from the first material, the system comprising:
a control unit comprising a processor and a memory;
a user interface operatively connected to the control unit, the user interface responsive to user input for causing the processor of the control unit to:
set a first layer pulse duration in a millisecond range;
set a first layer pulse shape defining a varying energy level over time for a first layer pulse;
set a second layer pulse duration in the millisecond range; and
set a second layer pulse shape defining a varying energy level over time for a second layer pulse; and
a laser emitting device operatively connected to the control unit and configured for receiving command signals from the control unit and generating at least one first layer pulse having the first layer pulse duration and the first layer pulse shape to drill the hole through the first layer and at least one second layer pulse having the second layer pulse duration and the second layer pulse shape to drill the hole through the second layer.

12. The system of claim 11, wherein the user interface is responsive to user input comprising drilling parameters, and the processor is configured for selecting the first layer pulse duration, first layer pulse shape, second layer pulse duration, and second layer pulse shape as a function of the drilling parameters.

13. The system of claim 12, wherein the drilling parameters comprise at least one of a material type, a material thickness, a number of layers, a drilling angle, and a hole size.

14. The system of claim 11, wherein at least one of the first layer pulse shape and the second layer pulse shape comprises at least two segments separated by an energy level of zero within a single pulse.

15. The system of claim 14, wherein the single pulse is generated multiple times to drill at least one of the first layer and the second layer.

16. The system of claim 11, wherein the second layer pulse shape is different from the first layer pulse shape.

17. The system of claim 16, wherein the second layer pulse duration is different from the first layer pulse duration.

18. The system of claim 11, wherein the control unit and user interface are part of a power supply for the laser emitting device.

19. The system of claim 11, wherein the laser emitting device operates at a wavelength smaller than about 1080 nm.

20. A method for drilling a hole in a component, the component composed of at least a first layer of a first material and a second layer of a second material different from the first material, the method comprising:
drilling through the first layer by applying at least one first pulse from a laser, the at least one first pulse having a first pulse duration in a millisecond range and a first pulse shape defining a varying energy level over time; and
drilling through the second layer by applying at least one second pulse from the laser, the at least one second pulse having a second pulse duration in a millisecond range and a second pulse shape defining a varying energy level over time, at least one of the first pulse duration and the first pulse shape being different from the second pulse duration and the second pulse shape, respectively.

21. The method of claim 20, wherein at least one of the first pulse shape and the second pulse shape comprises at least two segments separated by an energy level of zero within a single pulse.

22. The method of claim 21, wherein at least one of applying at least one first pulse and applying at least one second pulse comprises repeatedly applying the single pulse until having drilled through a respective one of the first layer and the second layer.

23. The method of claim 21, wherein at least one of applying at least one first pulse and applying at least one second pulse comprises applying a single one of the at least one first pulse and the at least one second pulse to drill through a respective one of the first layer and the second layer.

24. The method of claim 22, wherein applying at least one first pulse comprises applying a first plurality of segmented and repeated pulses to drill through the first layer, and wherein applying at least one second pulse comprises applying a second plurality of segmented and repeated pulses to drill through the second layer.

25. The method of claim 24, wherein the first plurality of segmented and repeated pulses differ from the second plurality of segmented and repeated pulses in at least one of duration and shape.

26. The method of claim 24, wherein the first plurality of segmented and repeated pulses differ from the second plurality of segmented and repeated pulses in at least one of number of segments per pulse and duration of each segment.
